(19) United States
(12) Patent Application Publication
(10) Pub. No.: US 2008/0063199 A1
(43) Pub. Date: Mar. 13, 2008

(54) Information recording apparatus and control method thereof

(75) Inventors: Kazuya Kimura, Hamura-shi (JP); Takeshi Kumagaya, Hachioji-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/783,386

(22) Filed: Apr. 9, 2007

(30) Foreign Application Priority Data
Apr. 28, 2006 (JP) 2006-127065

(51) Int. Cl. H04N 7/167; H04L 9/14

(52) U.S. Cl. 380/201; 380/45

(57) ABSTRACT

According to one embodiment, an information recording apparatus generates a plurality of mutually different title keys so as to conform to rules stipulating the respective ways of handling titles, executes an encryption process on the generated plurality of title keys by using corresponding respective rules and collectively records the encrypted title keys according to the respective rules as a plurality of title key files on a recording medium.

### CROSS-REFERENCE TO RELATED APPLICATIONS

This application is based upon and claims the benefit of priority from Japanese Patent Application No. 2006-127065, filed Apr. 28, 2006, the entire contents of which are incorporated herein by reference.

### BACKGROUND

1. Field

One embodiment of the invention relates to an information recording apparatus for writing information on a write once type recording medium where information can be written once in each recording region thereof and also to a control method to be used for such an apparatus.

2. Description of the Related Art

As is well known, optical disks such as digital versatile disks (DVDs) have become very popular as digital recording media in recent years. Additionally, standards have been completely stipulated for DVDs of the next generation that correspond to so-called high-vision and are capable of recording with a density higher than that of DVDs. Such disks are referred to as high-definition (HD) DVDs and Blu-ray.

The standards for DVDs of the next generation include the content protection standard, which is referred to as the Advanced Access Content System (AACS) standard, for preventing various titles (content) recorded on optical disk recording media from being illegally copied.

According to the AACS standard, the title key used to encrypt a title when executing an encryption process on the title and recording it on an optical disk is also encrypted according to the Usage Rules that defined for handling titles and the encrypted title key is recorded in a file on the optical disk.

When the title is to be reproduced, the title key used to encrypt the title to be reproduced out of the plurality of titles recorded on the optical disk is taken out from the file and decrypted according to the Usage Rules. Then, the title to be reproduced is subjected to a decryption process by means of the decrypted title key.

Meanwhile, the AACS standard prohibits the user from updating a title key file that has been written on a write once type optical disk. In other words, it is not possible to use the technique of generating a title key each time a title is recorded and writing it in a file for a great inconvenience on the part of the user.

Jpn. Pat. Appln. Publication No. 2004-22085 discloses an arrangement for efficiently moving or deleting a title in a folder by re-encrypting the folder key and all the title keys in the folder if the user wants to move or delete the title but re-encrypting only the folder keys of the folders that do not have any title that the user wants to move or delete.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram of an embodiment of the present invention that is a recording/reproduction apparatus, illustrating the configuration thereof;

FIG. 2 is a block diagram of the title key encryption process means of the recording/reproduction apparatus of the embodiment of FIG. 1;

FIG. 3 is an illustration of a title key file where the encryption title keys generated by the title key encryption process means of the recording/reproduction apparatus of the embodiment of FIG. 1 are collectively held;

FIG. 4 is a block diagram of the title key decryption process means of the recording/reproduction apparatus of the embodiment of FIG. 1, illustrating the configuration thereof;

FIG. 5 is a block diagram of the title encryption process means of the recording/reproduction apparatus of the embodiment of FIG. 1, illustrating the configuration thereof;

FIG. 6 is a flowchart of an exemplar operation of the title key encryption process of the recording/reproduction apparatus of the embodiment of FIG. 1;

FIG. 7 is a flowchart of an exemplar operation of the title encryption process of the recording/reproduction apparatus of the embodiment of FIG. 1;

FIG. 8 is a flowchart of another exemplar operation of the title key encryption process of the recording/reproduction apparatus of the embodiment of FIG. 1; and

FIG. 9 is a flowchart of another exemplar operation of the title encryption process of the recording/reproduction apparatus of the embodiment of FIG. 1.

### DETAILED DESCRIPTION

Various embodiments according to the invention will be described hereinafter with reference to the accompanying drawings. In general, according to one embodiment of the invention, an information recording apparatus generates a plurality of mutually different title keys so as to conform to rules stipulating the respective ways of handling titles, executes an encryption process on the generated plurality of title keys by using corresponding respective rules and collectively records the encrypted title keys according to the respective rules as a plurality of title key files on a recording medium.

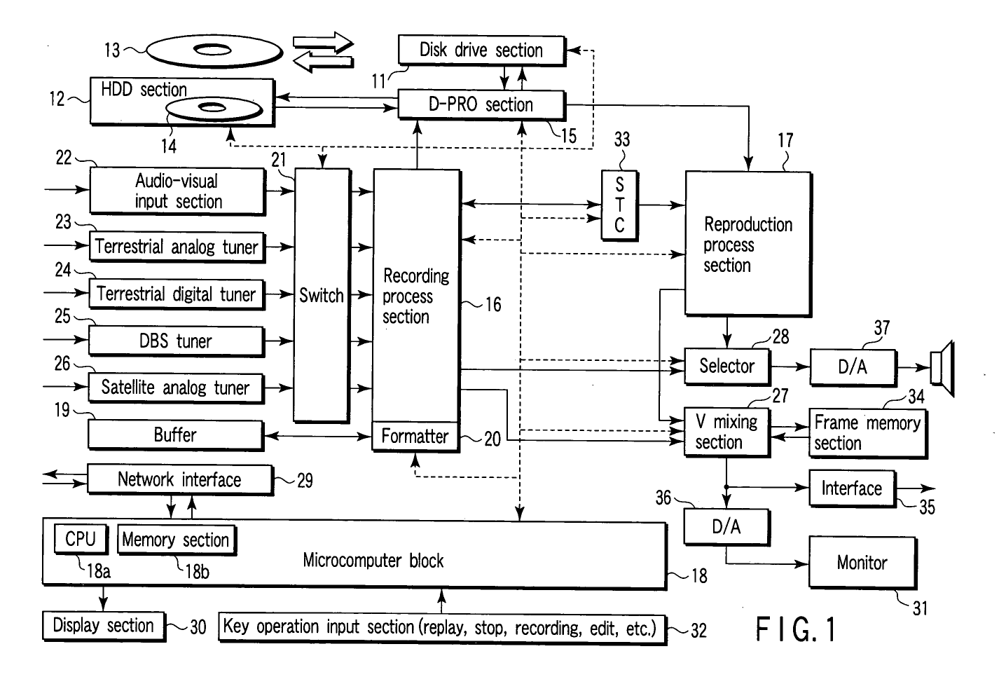

FIG. 1 is a schematic block diagram of an embodiment of the present invention that is a recording/reproduction apparatus, illustrating the configuration thereof. While the recording/reproduction apparatus of FIG. 1 is adapted to handle both optical disks including DVDs and a hard disk, it may be modified so as to be able to handle semiconductor memories.

In FIG. 1, the left half roughly shows the main blocks of the recording section and the right half roughly shows the main blocks of the reproduction section of the apparatus.

The recording/reproduction apparatus of FIG. 1 has disk drives of two different types that include a disk drive section 11 and a hard disk drive (HDD) section 12. Firstly, the disk drive section 11 drives an optical disk 13 to rotate and reads/writes information. The optical disk 13 will be referred to as the first information recording medium where video files can be formed hereinafter. The disk drive section 11 has a rotation control system, a laser drive system and an optical system among others. The HDD section 12 drives a hard disk 14, which will also be referred to as the second information recording medium hereinafter.

Referring to FIG. 1, a data processor section 15 is adapted to supply data to be recorded to the disk drive section 11 and the HDD section 12 and receive reproduced signal. The data processor section 15 handles data to be recorded and reproduced data on a unit by unit basis and includes a buffer circuit, a modulation/demodulation circuit and an error correcting section.

The recording/reproduction apparatus of FIG. 1 comprises as principal components a recording process section 16 that operates as the recording side of the apparatus, a reproduction process section 17 that operates as the reproduction side of the apparatus and a microcomputer block 18 that controls the operation of the apparatus main body. The recording process section 16 includes a transport stream process section and a plurality of encoders.

The recording process section 16 basically has an analog-to-digital converter for digitizing both video and audio analog signals input to it, a video encoder and an audio encoder as well as a sub video encoder.

The encoded output of the recording process section 16 is converted to show a predetermined DVD format by the formatter 20 that includes a buffer memory 19 and subsequently supplied the above-described data processor section 15. There may be cases where a packet elementary stream that is extracted from a transport stream is recorded in the hard disk 14 from the recording process section 16 directly by way of the HDD section 12.

The recording process section 16 can input the external analog video signals and the external analog audio signals obtained from audio-visual input section 22 by way of a switch 21.

The recording process section 16 can selectively input the signals received by terrestrial wave analog tuner 23, terrestrial wave digital tuner 24, direct broadcast satellite (DBS) tuner 25 and satellite analog tuner 26 by way of the switch 21.

When the plurality of encoders are operated by the recording process section 16, it is possible for the user to record the program received by the terrestrial wave digital tuner 24 in the HDD section 12 and watch/listen in the program received by the DBS tuner 25 simultaneously.

When compressed digital video signals and digital audio signals are directly input to the recording process section 16, it is possible to directly supply the compressed digital video and digital audio signals to the formatter 20. Additionally, the recording process section 16 can directly supply the digital video signal and audio signal that have been subjected to analog-to-digital conversion to video mixing section 27 and audio selector 28.

The recording process section 16 also includes a Moving Picture Experts Group (MPEG) video encoder that compresses digital video signal at a variable bit rate according to the MPEG 2 or MPEG 1 standard.

Digital audio signals are compressed at a fixed bit rate according to the MPEG or Audio Compression (AC)-3 standard or by linear pulse code modulation (PCM).

When sub video signals are input from audio-visual input section 22 (such as signals from a DVD video player equipped with an independent output terminal for sub video signals) or when DVD video signals having such a data configuration are broadcast and received by a television (TV) tuner (not shown), the sub video signals in the DVD video signals are encoded (by run length coding) by the sub video encoder and make bitmaps of sub images.

Encoded digital video signals, digital audio signals and sub image data are turned to packs by the formatter 20 such as video packs, audio packs and sub video packs, which are then put together and converted so as to take a format, which may be a format defined by the DVD-Video standard (DVD-video format) or a format defined by the DVD-Recording standard (DVD-VR format). The formatter 20 utilizes the buffer memory 19 for the above-described conversion process.

The recording/reproduction apparatus of FIG. 1 is adapted to supply the information formatted by the formatter 20 (packs of video, audio and sub video data) and prepared management information to the HDD section 12 or the disk drive section 11 by way of the data processor section 15 and record them on the hard disk 14 or the optical disk 13.

The recording/reproduction apparatus can also record the information recorded on the hard disk 14 or the optical disk 13 on the optical disk 13 or the hard disk 14 by way of the data processor section 15 or the disk drive section 11, whichever appropriate.

Additionally, the recording/reproduction apparatus can execute an editing process of deleting part of the video objects of a plurality of programs and/or coupling different programs recorded on the hard disk 14 or the optical disk 13.

The above-described microcomputer block 18 includes a central processing unit (CPU) 18a and a memory section 18b which by turn includes a read-only memory (ROM) where a control program is written among others, a RAM adapted to provide a work area necessary for executing a program and a non-volatile memory for recording various pieces of setting information among others.

The microcomputer block 18 can be connected to an external network by way of network interface 29. Then, it can take in dynamic electronic program guides (DEPGs) from external servers.

Additionally, the CPU 18a of the microcomputer block 18 is adapted to perform various operations such as detecting defective spots and unrecorded regions, selecting video information recording positions, recording the universal disk format (UDF) and selecting audio-visual addresses by using the RAM as work area according to the control program stored in the ROM of the memory section 18b.

The microcomputer block 18 additionally has various information processing sections necessary for controlling the blocks of the recording/reproduction apparatus in a coordinated manner. Although not shown, the information processing sections include a directory detecting section, a video manager (VMG) information (overall video management information) preparing section, a copy-related information detecting section, a copy and scrambling information (RDI) processing section, a packet header processing section, a sequence header processing section and an aspect ratio information processing section.

Furthermore, the microcomputer block 18 has an editing time management information control section for controlling management information during an editing process and a video recording time management information control section for controlling management information during a video recording process.

Of the results of operations of the microcomputer block 18, those that are to be notified to the user are displayed on the display section 30 of the recording/reproduction apparatus or on the monitor display 31 on an on-screen display (OSD) basis.

The microcomputer block 18 also has a key operation input section 32 for inputting operation signals necessary for operating the recording/reproduction apparatus. The key operation input section 32 corresponds to the operation switches arranged on the main body of the recording/reproduction apparatus and remote controllers (not shown). It may be a personal computer (PC) connected to the recording/reproduction apparatus by means of wired communications or wireless communications (which may be optical communications and/or infrared communication). In any mode of arrangement, the user can record the input video/audio signals and reproduce and edit any of the recorded contents by operating the key operation input section 32.

The microcomputer block 18 can control the disk drive section 11, the HDD section 12, the data processor section 15, the recording process section 16 and/or the reproduction process section 17 at timings that are based on the time data from a system time clock (STC) 33. While processing operations for signal recording and/or reproduction are normally conducted in synchronism with the time clock from the STC 33, other processing operations may be conducted at timings independent of the STC 33.

The reproduction process section 17 has a separator for separating the packs from the signals of the DVD format having a pack structure, a buffer memory to be used for separating packs and processing signals otherwise, a video (V) decoder for decoding the main video data (the contents of the video packs) separated by the separator, a sub-picture (SP) decoder for decoding sub video data (the contents of the sub video packs) separated by the separator and an audio (A) decoder for decoding the audio data (the contents of the audio packs) separated by the separator. It also has a video processor for appropriately synthetically combining a decoded main image and decoded one or more than one sub images such as a menu, highlight button and subtitles to superimpose the latter on the former and output the combined image.

The video signals output from the reproduction process section 17 are input to the video mixing section 27. The video mixing section 27 synthetically combines the video signals and text data, for example. The video mixing section 27 is connected to a line to be used for directly taking in the signals from the TV tuner section and the audio-visual input section 22 described above. The video mixing section 27 is also connected to a frame memory 34 to be used as buffer. The output of the video mixing section 27 is sent out to the outside by way of an interface 35 when it is an analog output, whereas it is sent out to the outside by way of a digital-to-analog converter 36 when it is a digital output.

The output audio signals of the reproduction process section 17 are subjected to digital-to-analog conversion by a digital-to-analog converter 37 by way of the audio selector 28 before they are sent out to the outside. The audio selector 28 is controlled by the select signal from the microcomputer block 18. Thus, the audio selector 28 can directly select audio signals coming through the recording process section 16 when directly monitoring the digital signals from the TV tuner section and the audio-visual input section 22.

The formatter 20 of the recording process section 16 prepares cutting apart information and periodically transmits it to the CPU 18a of the microcomputer block 18 during a recording operation (such as information on a group of pictures [GOP] head interrupt time). The cutting apart information may include the number of packs of a video object unit (VOBU), the end address of the intra (I) picture from the head of the VOBU, and the reproduction time of the VOBU.

At the same time, the information from the aspect ratio information processing section is sent to the CPU 18a at the time of starting a recording operation and the CPU 18a prepares video object (VOB) stream information (STI). The STI contains resolution data and aspect data among others and are used by the decoder sections for initialization at the time of reproduction.

The recording/reproduction apparatus is so adapted as to record a video file on a DVD. A minimally continuous information unit (size) is defined in the recording/reproduction apparatus in order to continue a reproduction process without interruption while accessing (seeking) data. The unit is referred to as contiguous data area (CDA). The CDA size is a multiple of an error correcting code (ECC) block (16 sectors) and a video file is recorded on a CDA unit basis in the file system.

The data processor section 15 receives data from the formatter 20 of the recording process section 16 on a VOBU basis and supplies data to the disk drive section 11 or the HDD section 12 on a CDA unit basis.

The CPU 18a of the microcomputer block 18 prepares management information necessary for reproducing recorded data and, when it recognizes a command for ending a data recording process, it transmits the management information it prepares to the data processor section 15. Accordingly, the management information is recorded on the optical disk 13 or the hard disk 14. Thus, while an encoding operation is in progress, the CPU 18a of the microcomputer block 18 receives information on the data unit (cutting apart information, etc.) from the recording process section 16.

Additionally, at the time of starting a recording process, the CPU 18a of the microcomputer block 18 recognizes the magnification information (file system) read out from the optical disk 13 or the hard disk 14 and also the unrecorded areas of the disk in order to specify a data recording area on the disk by way of the data processor section 15.

Now, the characteristic configuration and the operation of the recording process section 16 of the recording/reproduction apparatus will be described below. The recording process section 16 can execute an encryption process on a title, conforming to the AACS Standard. The encrypted title is then recorded on the optical disk 13.

At this time, the recording process section 16 executes an encryption process on the title key that is used for encrypting the title by means of the Usage Rules defined for titles. Then, the encrypted title key is recorded on the optical disk 13 as title key file.

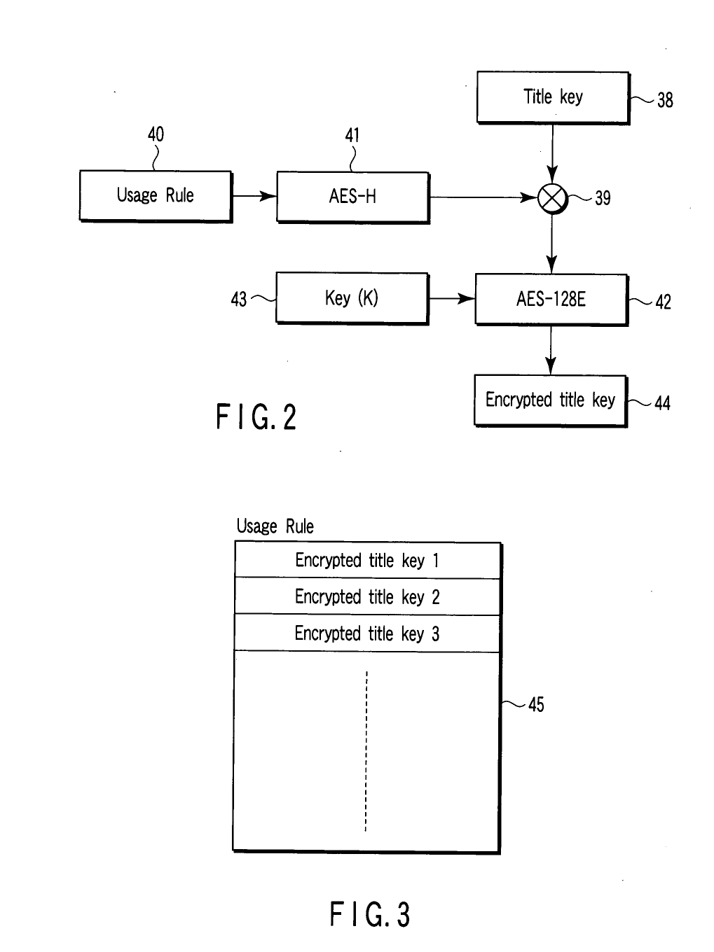

FIG. 2 is a schematic block diagram of the title key encryption process means of the recording process section 16 of the recording/reproduction apparatus of this embodiment to be used for executing an encryption process on a title key by means of the Usage Rules. The title key 38 is exclusive-ORed with the value obtained by executing a hash process on the (information on) Usage Rule 40 in encryption section 41 that conforms to the Advanced Encryption Standard (AES)-H system by the exclusive-OR circuit 39.

Then, the output of the exclusive-OR circuit 39 is supplied to encryption section 42 that conforms to the AES-128E system and subjected to an encryption process using a predetermined key (K) 43 to obtain an encrypted title key 44 that is encrypted by means of the Usage Rules.

The above-described AACS standard prohibits the user from updating a title key file that has been written on a write once type optical disk 13. In other words, it is not possible to use the technique of writing the title key used for encrypting a title in a title key file once when the title is recorded the optical disk 13 at inconvenience on the part of the user.

Therefore, this embodiment generates a plurality of mutually different title keys 38 in advance for each of all the types of Usage Rules. Then, the title key encryption process means illustrated in FIG. 2 executes an encryption process on each of the generated title keys 38. Note that a Usage Rule 41 that corresponds to the type of the title key 38 to be encrypted is applied.

Then, the plurality of encrypted title keys 44 generated for each of all the types of Usage Rules are put together in a plurality of title key files 45 for the respective Usage Rules as shown in FIG. 3 and recorded on the write once type optical disk 13.

When encrypting a title and write it on the output disk 13 once, the title key file 45 that corresponds to the applicable Usage Rule is selected from the plurality of title key files 45 recorded on the output disk 13.

Thereafter, one of the encrypted title key 44 is read out from the selected title key file 45 and the read out and encrypted title key 44 is decrypted to the original title key 38 by means of the corresponding Usage Rule. The decrypted title key 38 is used to execute an encryption process on a title to be written and the encrypted title is recorded on the optical disk 13.

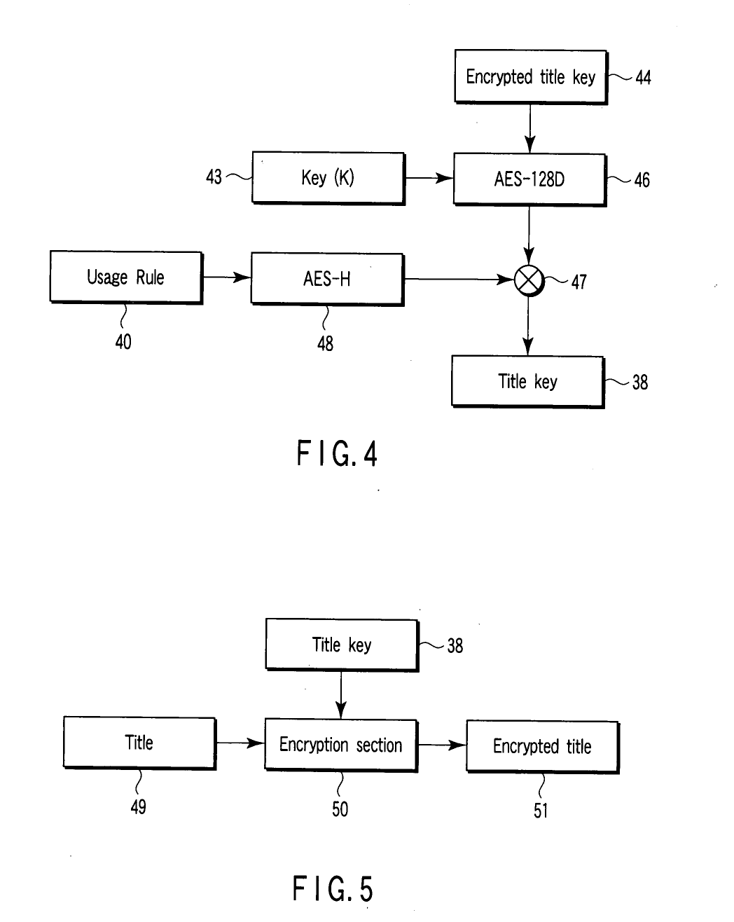

FIG. 4 is a schematic block diagram of the title key decryption process means of the recording/reproduction apparatus of this embodiment to be used for the decryption process that is to be executed on the encrypted title key 44 by means of the Usage Rule in the recording process section 16. Referring to FIG. 4, the encrypted title key 44 is supplied to the decryption section 46 that conforms to the AES-128D system and a decryption process is executed on it, using the key (K) 43.

Then, the output of the decryption section 46 is exclusive-ORed with the value obtained by executing a hash process on the (information on) Usage Rule 40 in the encryption section 48 that conforms to the AES-H System by the exclusive-OR circuit 47, to obtain the original title key 38.

Thereafter, as shown in FIG. 5, the title 49 to be written on the optical disk 13 once is supplied to the encryption section 50 and subjected to an encryption process by means of the title key 38 that is decrypted in a manner as described above. Thus, the encrypted title 51 is written on the optical disk 13 once.

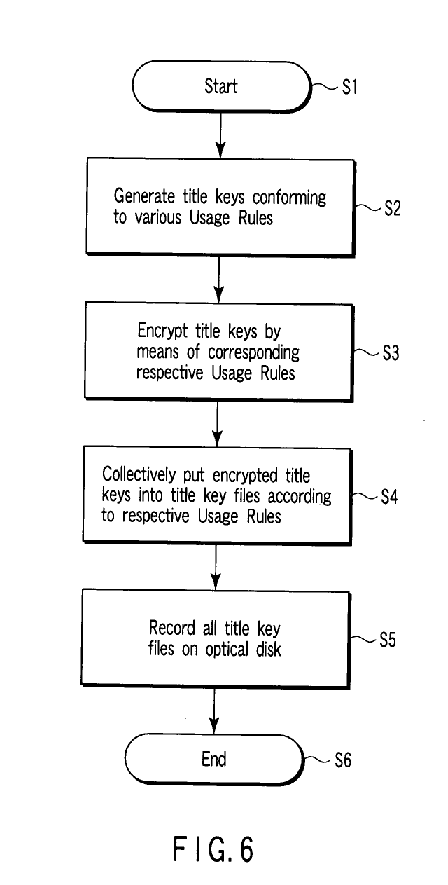

FIG. 6 is a flowchart of an exemplar operation of the title key encryption process of the recording/reproduction apparatus of this embodiment, where the plurality of title keys 38 generated respectively for all the types of Usage Rules are encrypted and recorded on the write once type optical disk 13. Referring to FIG. 6, as the process is started (step S1), the recording process section 16 generates title keys 38 that correspond to various Usage Rules in step S2.

Then, in step S3, the recording process section 16 executes an encryption process on each of the generated title keys 38 by means of the corresponding Usage Rule 41 and, in step S4, it collectively puts the encrypted title keys 44 into a plurality of title key files 45 for the respective Usage Rules and in step S5, records them on the write once type optical disk 13 to end the process (step S6).

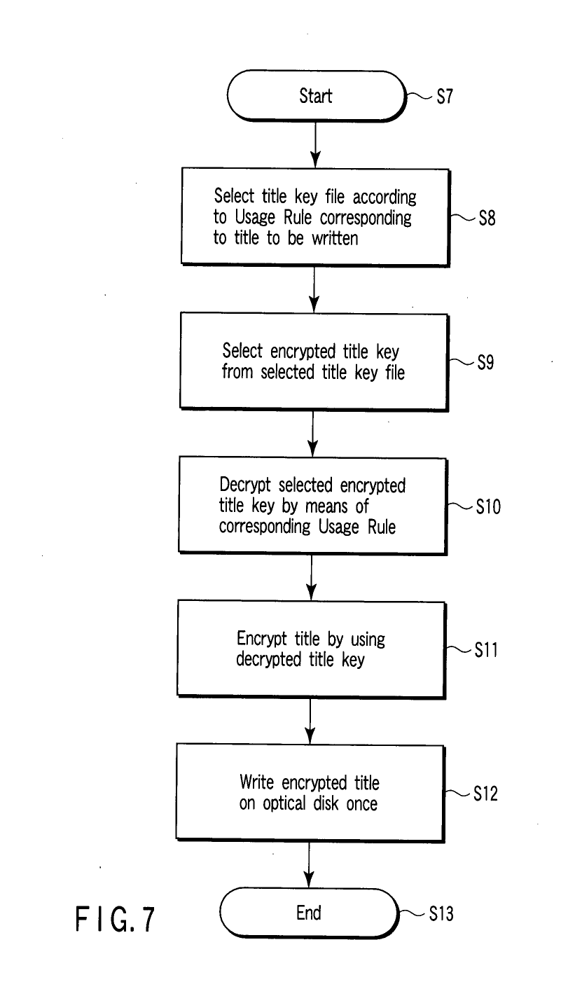

FIG. 7 is a flowchart of an exemplar operation of the title encryption process of the recording/reproduction apparatus of this embodiment, where a title 49 is encrypted by using one of the encrypted title keys 44 recorded on the optical disk 13 in the above-described manner and written on the optical disk 13 once. Referring to FIG. 7, as the process is started (step S7), the recording process section 16 selects the title key file 45 that corresponds to the applicable Usage Rule defined for the title to be recorded from the plurality of title key files 45 recorded on the optical disk 13 in step S8.

Then, in step S9, the recording process section 16 selects one of the encrypted title keys 44 from the selected title key file 45 and, in step S10, it decrypts the selected title key 44 by means of the corresponding Usage Rule to obtain the decrypted original title key 38.

Thereafter, in step S11, the recording process section 16 executes an encryption process on the title to be written once by means of the decrypted title key 38 and, in step S12, it records the encrypted title 51 on the optical disk 13 to end the process (step S13).

Thus, according to FIGS. 6 and 7, a plurality of title keys 38 are generated respectively for all the types of Usage Rules and encrypted and the encrypted title keys 44 are put into a plurality of title key files 45 for the respective Usage Rules and recorded on the write once type optical disk 13.

With this arrangement, it is possible to encrypt titles that correspond to all the types of Usage Rules and hence an encrypted title 51 can be written with ease on an write once type optical disk 13 once, for which the user is prohibited from updating the title key file 45 of the title key 38 to be used for encrypting a title 49, for a great convenience on the part of the user in terms of handling titles.

Now, other exemplar operations of this embodiment will be described below. In these operations, a plurality of mutually different title keys 38 are generated for a same Usage Rule and each of the generated title keys 38 is encrypted by the title key encryption process means illustrated in FIG. 2 by means of the Usage Rule. Then, the plurality of encrypted title keys 44 that correspond to the same Usage Rule are collectively put into a title key file 45, which is then recorded on a write once type optical disk 13.

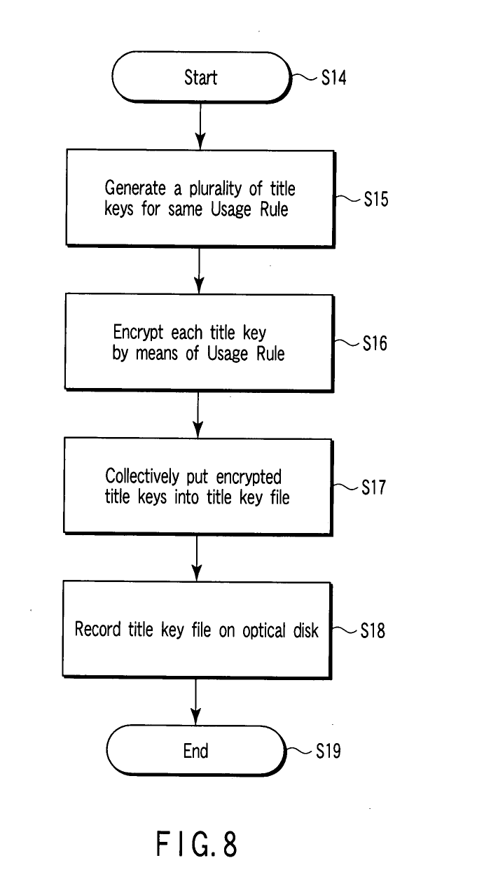

FIG. 8 is a flowchart of another exemplar operation of the title key encryption process of the recording/reproduction apparatus of this embodiment, where a plurality of mutually different title keys 38 are generated for a same Usage Rule and each of the generated title keys 38 is encrypted so that the encrypted title keys 38 may be put together into a title key file 45 and the title key file 45 may be recorded on a write once type optical disk 13. Referring to FIG. 8, as the process is started (step S14), the recording process section 16 generates a plurality of title keys 38 for a same Usage Rule in step S15.

Then, in step S16, the recording process section 16 executes an encryption process on each of the generated title keys 38 by means of the Usage Rule and, in step S17, it collectively puts the encrypted title keys 44 into a title key file 45. In step S18, the recording process section 16 records the title key file 45 on a write once type optical disk 13 to end the process (step S19).

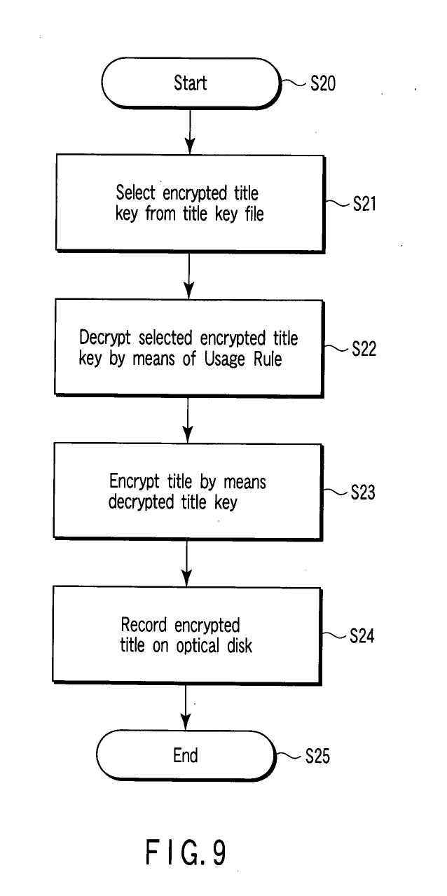

FIG. 9 is a flowchart of another exemplar operation of the title key encryption process of the recording/reproduction apparatus of this embodiment, where a title 49 is encrypted by using one of the encrypted title keys 44 recorded on the optical disk 13 in the above-described manner and written on the optical disk 13 once. Referring to FIG. 9, as the process is started (step S20), the recording process section 16 selects one of the encrypted title keys 44 from the title key file 45 recorded on the optical disk 13 in step S21 and decrypts the selected encrypted title key 44 to the original title key 38 by means of the Usage Rule in step S22.

Then, in step S23, the recording process section 16 executes an encryption process on the title to be written once, using the decrypted title key 38 and, in step S24, it records the encrypted title 51 on the optical disk 13 to end the process (step S25).

Thus, according to FIGS. 8 and 9, a plurality of title keys 38 are generated for a same Usage Rule and each of the generated title keys 38 is encrypted by means of the Usage Rule. Then, the plurality of encrypted title keys 44 are collectively put into a title key file 45, which is then recorded on a write once type optical disk 13.

With this arrangement, it is possible to use an arbitrarily selected title key 38 when writing a title 49 once. Then, it is possible to record a title that has already been recorded as another title corresponding to a same Usage Rule.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording apparatus for executing an encrypting process on a title and recording it on a write once type recording medium, the apparatus comprising:
a title key generating section which generates a plurality of mutually different title keys so as to conform to rules of a plurality of types stipulating the respective ways of handling titles;
a title key encrypting section which executes an encryption process on the plurality of title keys generated by the title key generating section by using respective pieces of information indicating the corresponding rules of a plurality of types stipulating the respective ways of handling titles; and
an encrypted title key recording section which collectively records the encrypted title keys encrypted by the title key encrypting section as a plurality of title key files according to the rules of a plurality of types stipulating the respective ways of handling titles on a recording medium.

2. An apparatus according to claim 1, further comprising:
a title key file selecting section which selects a desired title key file from the plurality of title key files recorded on the recording medium;
an encrypted title key selecting section which selects a desired encrypted title key from the title key file selected by the title key file selecting section;
an encrypted title key decrypting section which executes a decryption process on the encrypted title key selected by the encrypted title key selecting section by using the piece of information indicating the corresponding rule stipulating the way of handling the title; and
a title writing once section which executes an encryption process on the title requested to be recorded by using the title key decrypted by the encrypted title key decrypting section and writes the encrypted title on the recording medium once.

3. An information recording apparatus for executing an encrypting process on a title and recording it on a write once type recording medium, the apparatus comprising:
a title key generating section which generates a plurality of mutually different title keys so as to conform to a rule of a single type stipulating the way of handling titles;
a title key encrypting section which executes an encryption process on the plurality of title keys generated by the title key generating section by using respective pieces of information indicating the corresponding rule stipulating the way of handling titles; and
an encrypted title key recording section which collectively records the encrypted title keys encrypted by the title key encrypting section as a title key file on a recording medium.

4. An apparatus according to claim 3, further comprising:
an encrypted title key selecting section which selects a desired encrypted title key from the of title key file recorded on the recording medium;
an encrypted title key decrypting section which executes a decryption process on the encrypted title key selected by the encrypted title key selecting section by using the piece of information indicating the corresponding rule stipulating the way of handling the title; and
a title writing once section which executes an encryption process on the title requested to be recorded by using the title key decrypted by the encrypted title key decrypting section and writes the encrypted title on the recording medium once.

5. An apparatus according to claim 1 or 3, wherein
the title key encrypting section executes an encryption process on the outcome of an exclusive-OR of the title key generated by the title key generating section with the value obtained by executing a hash process on the piece of information indicating the rule stipulating the way of handling the title that corresponds to the title key by means of a predetermined key.

6. An apparatus according to claim 2 or 4, wherein
the encrypted title key decrypting section performs an exclusive-OR operation on the value obtained by means of the decryption process executed on the encrypted title key selected by the encrypted title key selecting section by means of the predetermined key and the value obtained by executing a hash process on the piece of information indicating the rule stipulating the way of handling the title that corresponds to the encrypted title key.

7. An apparatus according to claim 1, wherein
the rule stipulating the way of handling the title corresponds to a Usage Rule.

8. A control method to be used for an information recording apparatus for executing an encrypting process on a title and recording it on a write once type recording medium, the method comprising:
generating a plurality of mutually different title keys so as to conform to rules of a plurality of types stipulating respective ways of handling titles;
executing an encryption process on the generated plurality of title keys by using respective pieces of information indicating the corresponding rules of a plurality of types stipulating respective ways of handling titles; and
collectively recording the encrypted title keys as a plurality of title key files according to the rules of a plurality of types stipulating respective ways of handling titles on a recording medium.

9. A method according to claim 8, further comprising:
selecting a desired title key file from the plurality of title key files recorded on the recording medium;
selecting a desired encrypted title key from the selected title key file;
executing a decryption process on the selected encrypted title key by using the piece of information indicating the corresponding rule stipulating the way of handling the title; and
executing an encryption process on the title requested to be recorded by using the decrypted title key and writing the encrypted title on the recording medium once.

10. A control method to be used for an information recording apparatus for executing an encrypting process on a title and recording it on a write once type recording medium, the method comprising:
generating a plurality of mutually different title keys so as to conform to a rule of a single type stipulating the way of handling titles;
executing an encryption process on the generated plurality of title keys by using respective pieces of information indicating the corresponding rule stipulating the way of handling titles; and
collectively recording the encrypted title keys as a title key file on a recording medium.

11. A method according to claim 10, further comprising:
selecting a desired encrypted title key from the of title key file recorded on the recording medium;
executing a decryption process on the selected encrypted title key by using the piece of information indicating the corresponding rule stipulating the way of handling the title; and
executing an encryption process on the title requested to be recorded by using the decrypted title key and writing the encrypted title on the recording medium once.
